(19) United States
(12) Patent Application Publication
(10) Pub. No.: US 2008/0042807 A1
(43) Pub. Date: Feb. 21, 2008

(54) Rfid Reader Interface and Event Management Apparatus for Supporting Multi-Protocol-Based Heterogeneous Readers and Method Therefor

(76) Inventors: Joo-Sang Park, Daejon (KR); Tae-Su Cheong, Gapyeong-gun (KR); Hye-Jin Park, Daejon (KR); Yong-Joon Lee, Daejon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/722,171

(22) PCT Filed: Dec. 12, 2005
(86) PCT No.: PCT/KR05/04240

§ 371 Date: Jun. 19, 2007

(30) Foreign Application Priority Data
Dec. 20, 2004 (KR) 10-2004-0108845

(51) Int. Cl. H04Q 5/22

(52) U.S. Cl. 340/10.3

(57) ABSTRACT

Provided are a Radio Frequency Identification (RFID) reader interface supporting multiprotocol-based heterogeneous readers, and an event management apparatus and method therefor. The interface supports communication between heterogeneous readers and application systems, and remarkably reduces the amount of data to be sent to the application systems through event generation and data filtering. The interface includes: a reader connection management unit for and establishing connection between the RFID readers and the application systems; a reader transmission/reception processor for receiving tag data from the RFID readers or sending application system data to be converted into individual protocol data; the protocol processor for converting the tag data into the individual protocol data to support the heterogeneous RFID readers; and the middleware transmission/reception processor for sending the tag data converted into the common protocol data to the application systems or an RFID event management device, or receiving the application system data from the application systems.

### TECHNICAL FIELD

The present invention relates to a Radio Frequency Identification (RFID) reader interface and event management apparatus for supporting multi-protocol-based heterogeneous readers and method therefor, and more particularly, to an RFID reader interface and event management apparatus for supporting multi-protocol-based heterogeneous readers and method therefor, which are capable of supporting a communication between a plurality of heterogeneous readers using different protocols through a protocol conversion process and application systems, and also remarkably reducing the amount of data to be transferred to the application systems through an event generation and data filtering process with respect to RFID tag data collected.

### BACKGROUND ART

A conventional RFID reader interface and event management device is provided with a hardware unit such as RFID tag and reader, and a host application, or host, coupled therewith that receives and handles tag data, wherein the reader reads out data from the tag and then sends it to the host. However, such prior art device has several problems set forth below.

In systems designed under the assumption of a single kind of readers, a communication protocol between reader and host is limited to one type. Therefore, such system is improper to compositely structure and utilize heterogeneous readers together depending on a variety of use environments.

Further, when reader reads out data from tag and sends it, information on related event should be also included, together with tag data. This is because although the reader basically sends dozens of signals per second and reads out data allowed by the tag, it needs to properly filter the data read out since such data is not always correct and also know the meaning thereof as well as the read out state of data to properly cope with in the application systems.

In applying RFID technologies, reader should be first prepared to use RFID tag for SCM, warehouse management, item tracking, etc., and then connected to a system to manipulate such reader. In conventional technologies provided by companies such as Alien, Savi, and Matrics in U.S.A., however, such process should be performed by an operator through an operation window using an exclusive interface and a protocol provided by manufacturer of a specific reader device.

Moreover, such technologies should again process or extract tag data collected by reader, and provide the same to a related application system by a user's action, independently from RFID reader and host, in order to use such data in other systems. Namely, the conventional technologies are not automated and should employ only a single kind of equipments that depend on a specific interface and protocol.

In this case, however, the introduction of RFID tag and reader needs to carefully consider work to be conducted, object, environments, communications, etc.; and is also improper when considering selecting proper products according to each condition. That is, such requires handwork and has no compatibility; and does not provide automated connection management, tag data transmission and reception, and monitoring. In this regard, services supporting such functions as reader connection, data communication, and monitoring between reader and application system have been developed in Korea in recent years. However, such services do not consider multi-protocol and heterogeneous readers.

Meanwhile, in processing and transmitting tag data and events the reader reads out from the tag, generally, the identification value and user data for identification of the tag and tag attachment objects are involved in the tag. The reader reads out data stored in a tag memory of the tag, wherein a plurality of readers read out data from a large amount of tags and each reader repeatedly performs such process dozens of times per second. As a result, since the large amount of tag data is flowed into a system, a proper filtering is needed to extract only significant data necessary in application systems.

In addition, a continuous movement of things to which tag is attached, an increase of such things or various circumstances may be taken place within a readable distance of reader antenna. Therefore, using only tag data may not judge such circumstances; and thus, event information is needed to decide a state thereof. However, current commercial reader products provide no event information, which requires a separate process in host.

In this regard, SAVANT by EPC Global adopts a one-directional push mode which filters data continuously flowed from reader and then deliveries tag event information to a designated application system. This method gives priority to the process of events such as a filtering of tag data and a real time data delivery. However, this prior art method also has a drawback in that it is improper to see tag lists within a recognizable region of reader or reader group by a need of a user, rather than inflow of continuous tag events.

### DISCLOSURE OF INVENTION

### Technical Problem

It is, therefore, an object of the present invention to provide an RFID reader interface and event management apparatus for supporting multi-protocol based heterogeneous readers and method therefor, which are capable of supporting a communication between a plurality of heterogeneous readers using different protocols through a protocol conversion process and application systems, and also remarkably reducing the amount of data to be transferred to the application systems through the event generation and data filtering process with respect to RFID tag data collected.

### Technical Solution

In accordance with one aspect of the present invention, there is provided a Radio Frequency Identification (RFID) reader interface apparatus for multi-protocol based heterogeneous reader support for providing an interface between RFID readers and application systems, the apparatus comprising: a reader connection management means for identifying a plurality of RFID readers separately and establishing a connection between the RFID readers and the application systems; a reader transmission/reception process means for receiving tag data from the RFID readers or sending application system data to be converted into individual protocol data at a protocol process means to the corresponding RFID readers; the protocol process means for converting the tag data received by the reader transmission/reception process means into common protocol data or application system data received by a middleware transmission/reception process means into the individual protocol data, to support the heterogeneous RFID readers; and the middleware transmission/reception process means for sending the tag data converted into the common protocol data at the protocol process means to the application systems or an RFID event management device, or receiving the application system data from the application systems.

In accordance with another aspect of the present invention, there is provided an RFID event management apparatus for multi-protocol based heterogeneous reader support for managing events created from RFID readers, the apparatus comprising: a basic tag event data process and routing means for generating and filtering basic tag event data corresponding to a transition between certain states among tag data provided from the outside to route filtered basic tag event data to a corresponding application system; and a nonfiltered tag event data storing means for storing the basic tag event data.

In accordance with still another aspect of the present invention, there is provided an RFID reader interface method for multi-protocol based heterogeneous reader support for providing an interface between RFID readers and application systems, the method comprising the steps of: a) identifying a plurality of RFID readers separately, giving a reader identifier to each RFID reader, and establishing a connection between the RFID readers and the application systems using the reader identifiers; b) after the connection is established at the step a), receiving tag data from the RFID readers or sending application system data to be converted into individual protocol data at step c) below to the RFID readers; c) converting the tag data created in accordance with individual protocol every RFID reader into common protocol data or application system data prepared in accordance with common protocol into the individual protocol data, to support the heterogeneous RFID readers; and d) after the connection is established at the step a), sending the tag data converted into the common protocol data at the step c) to the application systems or an RFID event management device, or receiving the application system data from the application systems.

In accordance with still yet aspect of the present invention, there is provided an RFID event management method for multi-protocol based heterogeneous reader support for managing events created from RFID readers, the method comprising the steps of: a) creating basic tag event data corresponding to a transition between preset states out of tag data provided from the outside; b) performing a filtering with respect to the basic tag event data created at the step a); and c) delivering tag event data filtered at the step b) to the corresponding application system using a push mode.

### ADVANTAGEOUS EFFECTS

The present invention has advantages in that it can support the multi-protocol for the mutual compatibility and consistent management with respect to the heterogeneous readers, and also provide the event generation and data filtering function for the collected tag data.

Further, the present invention can apply a plurality of heterogeneous readers in various environments and enable integrated identification, connection, reader management associated therewith; and also enable the creation of state information and data filtering as well as simple tag data collection, without providing the state information by the reader.

In addition, the present invention can remarkably reduce the amount of information to be transmitted to the application systems, remove the redundancies therein, and provide the application systems with the tag data read out by the reader as well as information on states, by offering the event generation and data filtering function, under the RFID system environment which employs different tags or readers according to use environment, should allows the reader to simultaneously handle dozens to hundreds of tags, and should transfer several times to dozens of information per second with respect to one tag.

Moreover, the invention can filter data flowing from the reader at a real time to cope with various demands of the applications systems that are demanders of the RFID tag data and event, provide the push mode as transfer mode of the filtered data, together with the pull mode that creates and transfer the filtered tag data and events in response to the request of the application systems appropriately.

Finally, the present invention can accept the heterogeneous RFID tags and readers, filter the events created by the RFID readers and prevent the overload of the application systems, and transfer only the filtered events to the application systems at the real time.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram illustrating one embodiment of RFID reader interface and event management apparatus for supporting multi-protocol based heterogeneous readers in accordance with the present invention;

FIG. 2 is a detailed block diagram illustrating one embodiment of the RFID reader interface component 100 shown in FIG. 1 in accordance with the present invention;

FIG. 3 is a flowchart illustrating one embodiment of a reader connection method in the RFID reader interface component in accordance with the present invention;

FIG. 4 is a flowchart illustrating one embodiment of a data communication method in the RFID reader interface component in accordance with the present invention;

FIG. 5 is a flowchart illustrating one embodiment of a monitoring method in the RFID reader interface component in accordance with the present invention;

FIG. 6 is a detailed block diagram illustrating one embodiment of the RFID event management component shown in FIG. 1 in accordance with the invention;

FIG. 7 is a detailed block diagram illustrating one embodiment of the basic tag event data processor and router shown in FIG. 6 in accordance with the invention;

FIG. 8 shows one embodiment of the state transition for the basic tag event generation in the RFID event management component in accordance with the invention;

FIG. 9 is a detailed block diagram illustrating one embodiment of the filtered tag event data processor and router shown in FIG. 6 in accordance with the invention;

FIG. 10 is a flowchart illustrating one embodiment of a periodic process method of the filtered event tag data generation scheduler demon shown in FIG. 9 in accordance with the invention;

FIG. 11 is a view for explaining one embodiment of a method of storing the filtered event tag list information in the RFID event management component in accordance with the invention;

FIG. 12 is a flowchart illustrating one embodiment of a request and response method for the filtered tag event data in accordance with the invention;

FIG. 13 is a view describing a required factor when requesting to the filtered tag event handler in the RFID event management component in accordance with the invention;

FIGS. 14 and 15 are flowcharts illustrating embodiments of a double recognition removal filtering method in accordance with the invention;

FIGS. 16 to 20 are flowcharts illustrating embodiments of plural readers adjusting filtering method in accordance with the invention; and

FIG. 21 is a flowchart illustrating one embodiment of an RFID reader recognition error removal filtering method in accordance with the invention.

### BEST MODE FOR CARRYING OUT THE INVENTION

The above-mentioned objectives, features, and advantages will be more apparent by the following detailed description in association with the accompanying drawings; and based on the foregoing, the technical spirit of the invention will be readily conceived by those skilled in the art to which the invention belongs. Further, in the following description, well-known arts will not be described in detail if it seems that they could obscure the invention in unnecessary detail. Hereinafter, a preferred embodiment of the present invention will be set forth in detail with reference to the accompanying drawings.

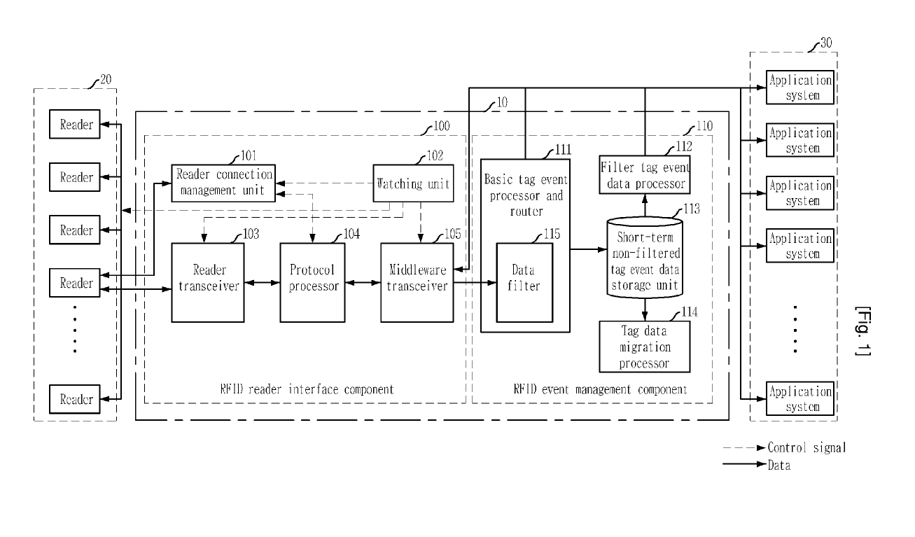

FIG. 1 is a block diagram illustrating one embodiment of an RFID reader interface and event management apparatus for supporting multi-protocol based heterogeneous readers in accordance with the present invention.

As shown in FIG. 1, the inventive RFID reader interface and event management apparatus 10 for supporting multi-protocol based heterogeneous readers comprises an RFID reader interface component 100 and an RFID event management component 110.

First of all, an outline of the present invention will be introduced below.

The present invention provides the compatibility and conversion of protocols to support a communication between a plurality of heterogeneous readers and application systems using different protocols; and also presents identification and management functions for connection management with respect to the readers, and a monitoring function. The connection management function includes reader profile management and inherent identifier issuance functions for heterogeneous reader management and inherent identifier issuance. When a communication with reader is started, the invention filters tag data collected by readers, judges and creates an appropriate event based on the filtered or extracted data, and transmits the tag data and event to an event processor.

The event management component that is in charge of the tag data filtering and event transmission can support both push mode and pull mode simultaneously, which filter data from the reader at a real time and delivers the filtered data, to cope with various requests of application systems that are users or demanders of RFID tag data and events.

An RFID reader may not have a tag recognition accuracy of 100% due to radio wave interference, reflection, etc., and can simultaneously recognize hundreds to thousands of tags per second in a noncontact manner. In this case, unnecessary data are generated, thereby raising a load to a system; and therefore, data filtering is needed. The present invention provides an appropriate filtering technique to be processed in an RFID system for filtering of event data accepted by such system.

A method of transmitting events after completing the above process to application systems can support two types of structures as follows. Firstly, upon support by push structure, such structure has a structure that facilitates the customizing with respect to the form of data filtering required by each domain and the flows until the final data demander. In this structure, data filtering method required by each domain may be determined and also registered and cancelled freely at the exterior. Also, the event transmission method of the invention can support the pull structure, together with the push structure as set forth above.

Hereinafter, a description will be made in detail with respect to FIG. 1. Firstly, the Reader Interface Component (RIC) 100 will be introduced below.

An operational procedure of the RFID interface component 100 for using heterogeneous readers having different protocols during communications is as follows.

Firstly, a reader connection establishment should be made. For this, a manager in the interface component first confirms system information built in the reader and the reader's profile managed by the interface component, adds information associated with the reader connection and installation thereto, gets an identifier issuance of the reader, and inputs it to the reader.

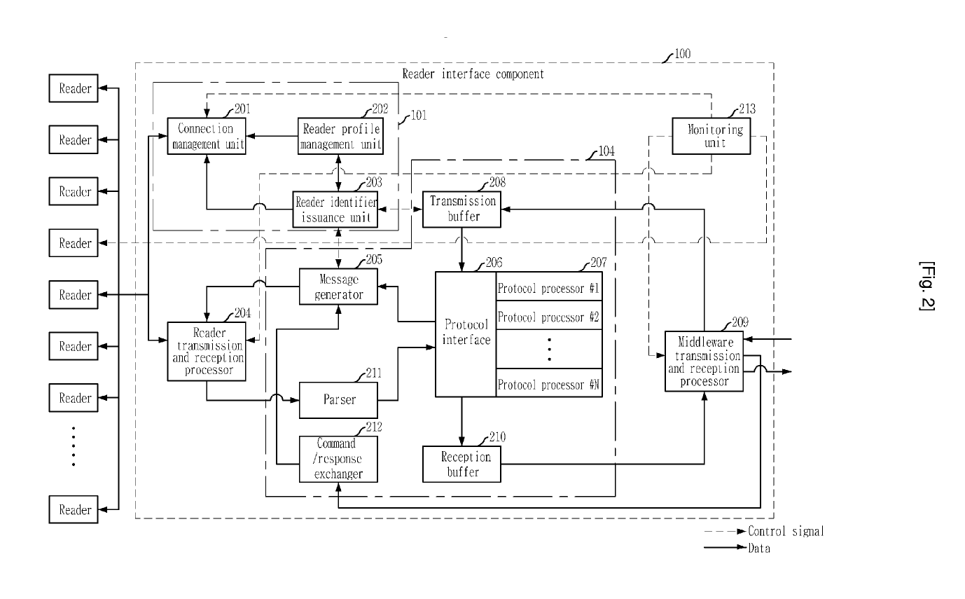

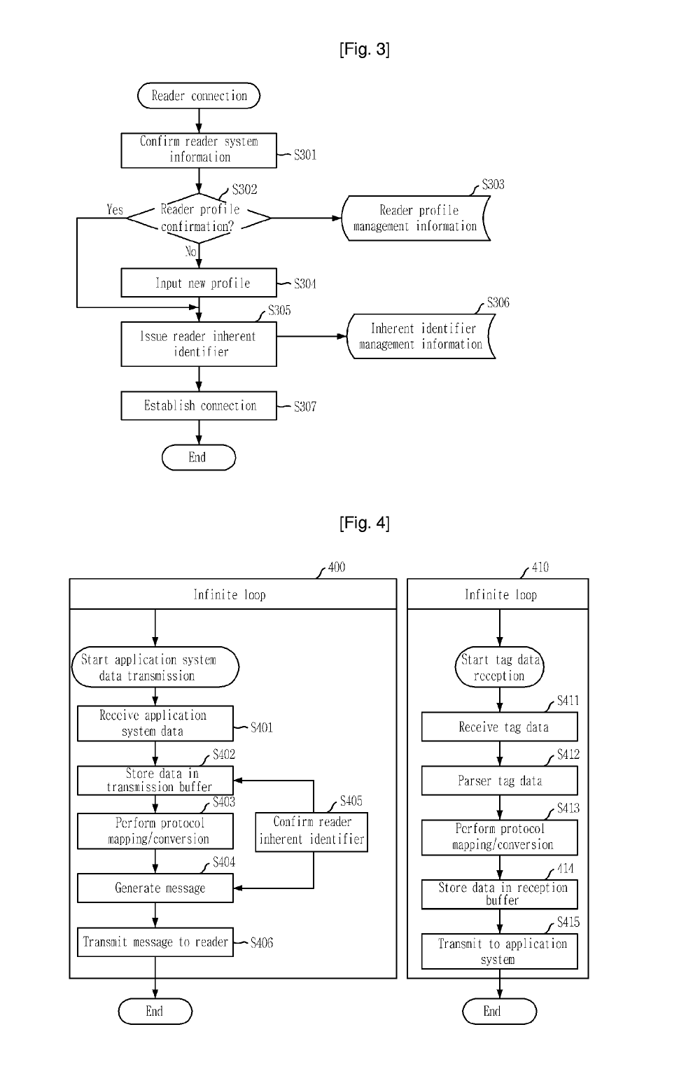

In commercial reader products, system information embedded in the reader contains reader name, manufacturing company, serial number, etc. However, since the item and standard of such information are all different from each other, identifier to be commonly used in the RFID system is issued and applied to that reader. With this process, the RFID system can identify and control a plurality of readers as consistent identifiers. After that, the system establishes communication channels of each of the readers based on the identifiers and commences the communications, which is shown in FIGS. 2 and 3.

Specifically, such an RFID system reads out or writes tag data via a reader according to a request of an application system. That is, the system receives tag data required by an application system and transmits it to a relevant reader together with a command, option and data value to allow the reader to write the data in the tag; or prompts a reader required by the application system to read out tag data and receives that data and transmit it to the application system. During this process, the interface component constructs data or identifies received data in harmonization with the protocol of each reader, while the application system enables the transmission and reception of data regardless of the protocol of each reader, which is shown in FIGS. 2 and 4.

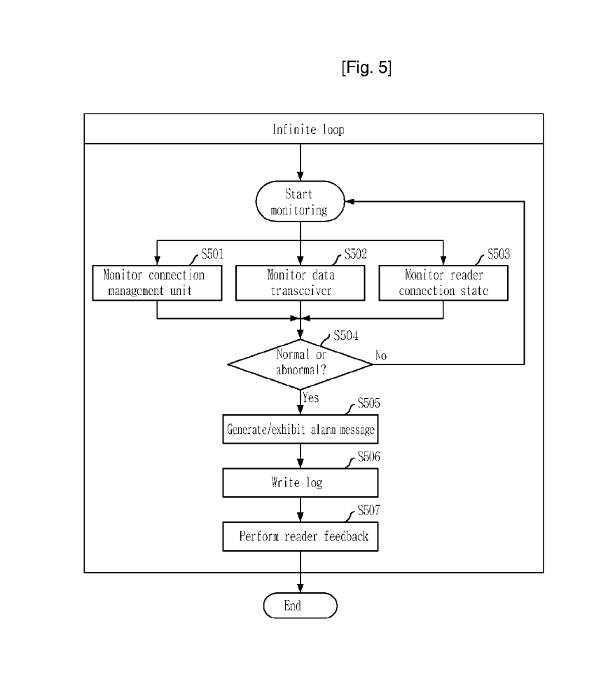

Thereafter, if the reader connection is established and the communication is started, the interface component periodically confirms the connection state of the reader, and the transmission and reception state of tag data. The confirmation of reader connection state is made by receiving and confirming a response message after a request of the reader's response periodically. And, the confirmation of data transmission and reception is done by confirming the amount of data accumulated in a buffer that stores data corresponding to a transmission request from the application system and data received from the reader. During the confirming process, if an abnormal state is founded, a notice message is provided to a user, and a log record and a feedback to a corresponding reader are made, which is shown in FIGS. 2 and 5.

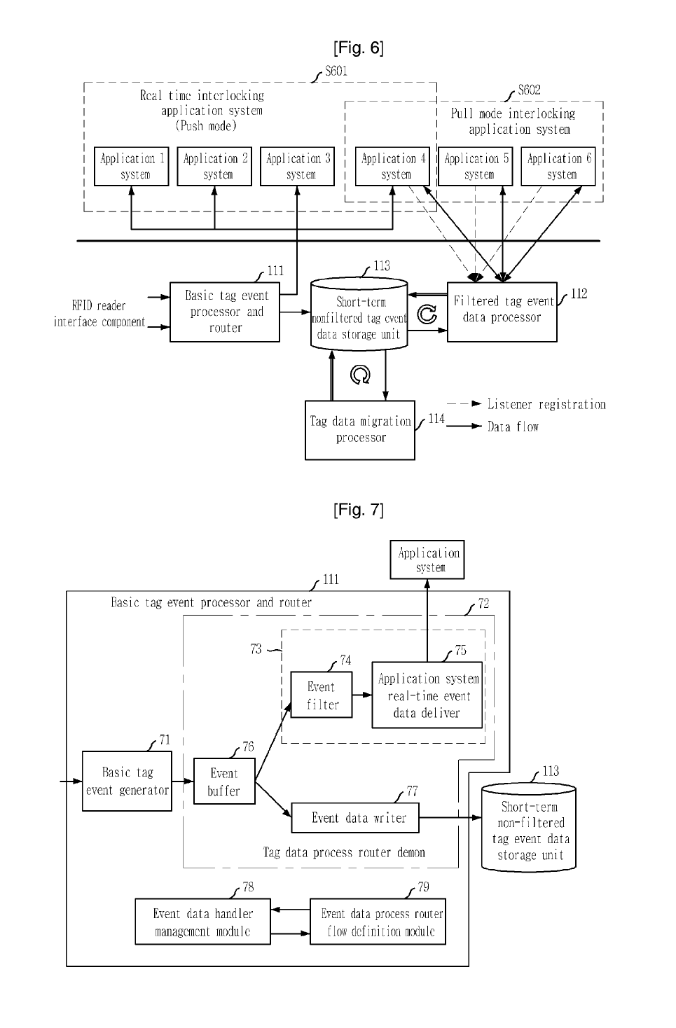

Meanwhile, the RFID event management component 110 will be described later referring to FIG. 6.

FIG. 2 is a detailed block diagram illustrating one embodiment of the RFID reader interface component 100 shown in FIG. 1 in accordance with the present invention.

First of all, each element of the RFID reader interface component 100 will be simply introduced.

A connection management unit 201 performs such functions as channel establishment, profile confirmation, and identifier issuance upon the reader connection, and a reader profile management unit 202 stores and manages readers' profiles such as readers' names, manufacturing companies, frequency bands, etc. And, a reader identifier issuance unit 203 carries out an inherent identifier issuance and management function of readers connected to the RFID system. The connection management unit 201, the reader profile management unit 202 and the reader identifier issuance unit 203 are the elements of the reader connection management unit 101 shown in FIG. 1.

Reader transmission and reception processors 103 and 204 function to transmit and receive tag data between the RFID system and the readers, and a message generator 205 creates commands and values for manipulation of the readers as messages using a relevant protocol.

In the meantime, a protocol process interface 206 serves to drive a specific protocol processor 207 for a request with respect to the communication protocols of the RFID system and the application systems, and for an analysis and process of messages received from the readers.

A protocol processor 104 performs a conversion of the protocols between the readers 20 and the application systems 30. This is because the request of the application systems 30 depend on the communication protocol predefined in the RFID system and the readers 20 is operated according to any specific protocol.

A transmission buffer 208 stores data to be transmitted from the application systems 30 to the readers 20, and a reception buffer 210 stores data received from the readers 20.

A middleware transmission and reception processor 209 is in charge of the process of transmission and reception of data between the readers 20 and the application systems 30.

A parser 211 parses messages from the readers 20 as their preprocessing.

A command/response exchanger 212 exchanges messages between the readers 20 for direct communication therebetween.

Monitoring units 102 and 213 monitor the connection state and operation of the readers and perform such functions as an alarm message creation, a log record, and a feedback to the relevant reader when an abnormal state is taken place.

Hereinafter, the important elements of the reader interface component 100 will be explained in detail with reference to FIGS. 2 to 5.

The connection management unit 201 establishes and manages a connection with respect to the readers 20 coupled with the RFID system. Conventionally, TCP/IP connection is made between the readers and the RFID system via a communication network. At this time, the connection management unit 201 confirms system information of newly connected readers and profile information of the readers stored in the reader profile management unit 202. It then takes an issuance of identifiers capable of commonly identifying with respect to all readers to which the RFID system is connected, irrespective of an individual identifier such as a type or manufacturer of each reader stored in the readers as the system information, and then administers mapping information thereon. Based on the mapping information, it identifies each reader and controls the operation of other elements of the RFID system or the readers by the application systems.

On the other hand, the reader profile management unit 202 has the functions as follows. For the installation and operation of the readers, the profile information thereof is needed. In conventional reader equipments, if a relevant command is inputted, system information is provided in response thereto. The system information includes reader name, manufacturer, reader type, usable frequency, object tag, tag protocol, manufacturing serial number, etc. This information is managed as one profile. When a same type of readers are additionally connected to the RFID system, the profile does not need to input newly but is replaced with the confirmation of the previous information merely.

Now, the functions of the reader identifier issuance unit 203 will be given below. Actually, in the field, a plurality of different types of readers is used, together with a plurality of same types of readers. In this case, it may not be possible to identify each reader using only its profile information. Further, although it may be possible to identify each reader using the manufacturing serial number in the system information, such information can not be used as a consistent identifier in the RFID system since a system and digit thereof are all different from each other every manufacturer or type of each reader. Accordingly, in order to write or read data in or from a specific tag using a specific reader, the RFID system should manage each reader separately, and therefore, a consistent inherent identifier is needed in the RFID system to identify each reader. As such, a processor for issuing and managing such an inherent identifier is just the reader identifier issuance unit 293 connected to the RFID system. For this, the processor employs information such as profile, network address, reader communication port number, activation state, reader installation position, manager, work purpose, etc.

Next, the functions of the protocol interface 206 will be provided below. The RFID system is placed between the application systems 30 and the readers 20; and functions to control the readers 20 according to the demand of the application systems 30, write or read data, and relay exchange of data. However, it may be impossible that the application systems or their users use all the communication protocols of each reader installed in the workshop under the recognition thereof. Therefore, the RFID system uses a predefined common protocol, wherein the common protocol is again converted into a protocol of each reader corresponding to a word object and then transmitted to the readers for correct operation thereof.

During this process, a process is required to convert a common protocol between the application systems and the RFID system into a specific protocol suitable for each reader. The protocol interface 206 servers to convert a message prepared according to the common protocol using an individual protocol processor 207. Conversely, it performs an inverse process for the application systems 30 to receive and process messages from each reader 20.

Meanwhile, the protocol processor 207 has the functions as follows. For example, if the user employs the application system 30 to read or write tag data, the system 30 delivers the tag data to the common protocol applied inside the RFID system. However, the protocol to control the operation of the readers 20 has messages that are constituted by commands, options, and values; and such protocol is different every reader's manufacturer. Thus, the conversion is needed to have the compatibility therebetween. The protocol processor 207 performs the conversion between the common protocol and the readers' protocols. Further, it receives commands and values from the common protocol and converts them into commands, options, and values that are in harmonization with the protocols of the relevant readers to perform their proper works.

In the meantime, the command/response exchanger 212 has the following functions. Among the command/response data to be transmitted from the reader interface component 100 to the application systems or RFID event management component via the middleware transmission and reception processor 209, it determines command/response data that are adapted for other readers to process directly and then feedbacks them to the reader transmission and reception processor 204. Due to the above process, the command/response data determined above are transmitted to the other readers via the reader transmission and reception processor 204. Alternatively, as shown in FIG. 2, the determined command/response data may be transmitted to another relevant reader via the message generator 205. In this case, the data is also transmitted to another relevant reader via the reader transmission and reception processor 204.

Through the functions of the command/response exchanger 212 as described above, the direct data exchange between the readers 20 is possible.

Meanwhile, the monitoring units 102 and 213 monitor the connection state and operation of the readers 20 and perform functions such as alarm message generation and log record, and feedback to the relevant reader when an abnormal state is occurred. In addition, they watch a power of the readers, network connection and operation state, and tag data transmission and reception state; and also watch reader profile and identifier issuance state and carries out alarm message generation and log record when there exists any change.

FIG. 3 is a flowchart illustrating one embodiment of a reader connection method in the RFID reader interface component in accordance with the present invention. This method is performed in the reader connection management unit 101.

The reader connection management unit 101 confirms system information of newly connected readers at step S301, and confirms, at step S302, whether or not there exists profile information of the newly connected readers via the reader profile information at step S303.

If it is confirmed that there is the reader profile information, at step S305, the reader connection management unit issues identifiers, i.e., readers' inherent identifiers, capable of commonly identifying with respect to the connected readers, via the inherent identifier management information at step S306.

However, if it is confirmed that there is no reader profile information, at step S304 the reader connection management unit receives new profile with respect to the connected readers, and issue identifiers (readers' inherent identifiers) via the inherent identifier management information at step S306.

After issuing the readers' inherent identifiers, the connection between the readers and the application systems is established at step S307.

FIG. 4 is a flowchart illustrating one embodiment of a data communication method in the RFID reader interface component in accordance with the present invention.

Firstly, the data transmission process from the application systems 30 to the readers 20 will be given via step S400.

The middleware transmission and reception processor 209 of the RFID reader interface component 100 receives data transmitted from the application systems 30 at step S401 and then stores it in a buffer 208 at step S402. During the storing, the confirmation of the relevant reader's identifier is also made.

And then, the protocol mapping/conversion with respect to the received data is performed by the protocol interface 206 and the protocol processor 207 of the RFID reader interface component 100. After that, the message generator 205 creates message at step S404, and then sends it to the readers 20 via the reader transmission and reception processor 204 at step S406. During the message creating step S404, the reader's inherent identifier is also confirmed at step S405.

In the following, the data transmission process from the readers 20 to the application systems 30 will be provided via step S410.

When the reader transmission and reception processor 204 of the RFID reader interface component 100 receives tag data from the readers 20 at step S411, the parser 211 parses it at step S412. The received data is protocol-mapped and converted by the protocol interface 206 and the protocol processor 207 at step S413 and then stored in the reception buffer 210 at step S414. Then, the middleware transmission and reception processor 209 sends the data stored in the reception buffer 210 to the application systems 30.

With the above process, the interface component constructs the data in harmonization with the protocol of each reader or classifies the received values, while the application systems enable the transmission and reception of data regardless of the protocol of each reader.

FIG. 5 is a flowchart illustrating one embodiment of a monitoring method in the RFID reader interface component in accordance with the present invention. This method is performed in the monitoring units 102 and 213.

The monitoring units 102 and 213 monitor a power of the readers, network connection state and operation state, and tag data transmission and reception state. And also, they watch reader profile, identifier issuance state, etc. at steps S501 to S503, and perform, if there is an abnormality or change, functions such as notice message generation and its display at step S505, log record at step S506, and feedback to the relevant reader. The above steps are continuously repeated.

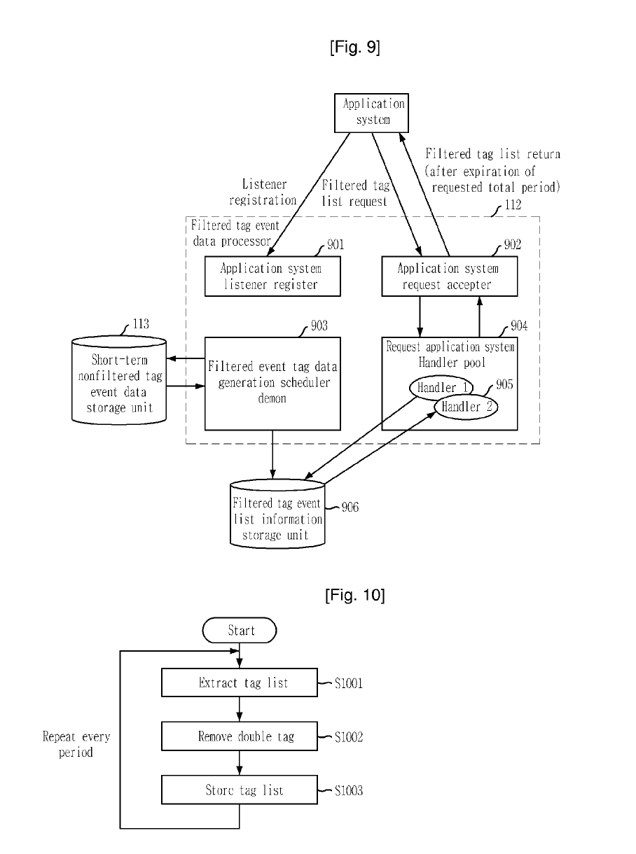

FIG. 6 is a detailed block diagram of the RFID event management component shown in FIG. 1 in accordance with the invention; and FIG. 7 is a detailed block diagram illustrating one embodiment of the basic tag event data processor and router shown in FIG. 6 in accordance with the invention, which supports the push mode and aims at real time tag event data processing/interlocking of the application systems. Further, FIG. 9 is a detailed block diagram illustrating one embodiment of the filtered tag event data processor shown in FIG. 6 in accordance with the invention, which supports the pull mode and aims at data handling of alerting, stock research, etc., mainly at a static state. These will be described below together.

The RFID event management component 110 firstly performs a filtering function, and secondly an event transmitting function.

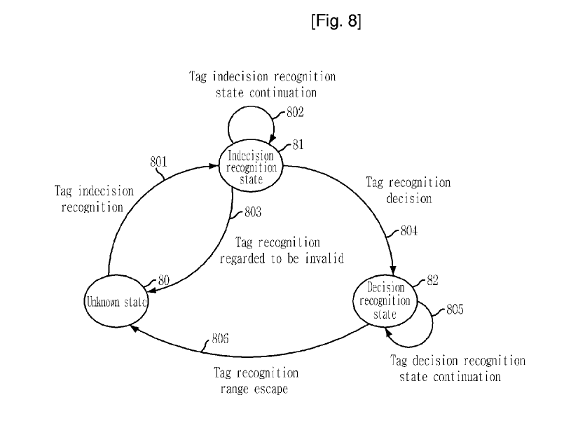

Firstly, the data filtering function will be discussed below. It is assumed that a state transition of event recognized in the RFID reader is made for basic tag event creation after the basic tag event generator 71 (see FIG. 8).

Tag data being transmitted from the RFID reader to the RFID system include four data as: “reader identifier,” “tag identifier,” “timestamp,” and “basic tag event type.” The data filtering is made based on the above data.

Secondly, the event transmitting function will be given in detail below. The event transmission is made in the pull mode and the push mode.

First of all, the push structure will be discussed. The RFID event management component 110 provides basic tag data filter module and user interface capable of registering filter module suitable for each domain. Further, the RFID event management component 110 provides basic tag data transfer module and user interface capable of registering transfer module by application systems that want the reception of tag data at a real time.

And also, the RFID event management component 110 provides filters suitable for the front and rear connection between each filter and transfer module and domain, and designers capable of selecting filters' values. In addition, the RFID event management component 110 stores, in a specific place, non-filtered tag event data flowing for backup data for the pull structure and history management during a short term (publication of information).

Now, the pull structure will be described in detail below.

The RFID event management component 110 stores filtered tag event data lists having multi-dimensional information representation obtained by processing/filtering by fixed periods based on the shot-term nonfiltered tag event data stored in the push system. This RFID event management component 110 provides a listener register capable of registering destination information and information format through which the individual application systems may get tag event data (subscription for information acceptance).

Further, the RFID event management component 110 sets a specific term and operation together with the listener ID information and performs the operation on the basis of the tag event data recognized during that term to transfer the result using information predetermined in the listener ID. In the process, the multi-dimensional filtered tag event data is used (the desired information is transferred and received in a predefined manner during the term of subscription).

Meanwhile, a system configuration of the RFID event management component (EMC) 110 will be given hereinafter.

As shown in FIG. 1, the overall structure of the RFID event management component 110 is based on “a Chain of Middleware” structure where the push and the pull process middleware is placed at the front and rear of the middle of the short-term non-filtered tag event data storage unit 113.

Referring to FIG. 6, the basic tag event data processor and router 111 supports the push structure and defines a state of significant data out of data from the readers. It transfers data only when a transition between data states takes place to reduce the amount of inflowing data firstly. Namely, this implies that it manages the inflowing data by readers and tags, that is, event creation process is applied to reader 1 and reader 2, respectively, with respect to same tags. Based on the above process, desired tag data is transmitted to the application system wishing the reception thereof via the setting of filters suitable for each domain and a combination thereof at a real time.

Meanwhile, the filtered tag event data processor 112 of FIG. 6 supports the pull structure. It first registers desired format and destination information with respect to each application system in the listener manner via an interface, which is typically SOAP based, provided in the processor. After that, at a desired time, it transfers a term wishing the reception of desired information by the systems, listener ID, and operation information on the tag event data lists collected during that term, thereby receiving tag data lists.

The RFID event management component 110 of the invention can support distinct services by adding the filtered tag event data processor 112 (see FIG. 6), compared to the existing Savant structure.

Now, each subsystem will be explained below.

Firstly, the basic tag event data processor and router 111 will be provided with reference to FIGS. 6 and 7.

As shown in FIG. 6, there are two modules: a management module describing a series of flows for properly filtering and transferring tag data flowing from the readers to the designated application system and a real time process module for processing data in harmonization with such flows.

A basic tag event generator 71 serves to flow into a system only relevant tag data when a transition is taken place between states in the state transition diagram shown in FIG. 8, wherein the state transition is called the basic tag event. And, the state management is made and maintained independently by readers for one tag.

In the meantime, a tag data process router demon 72 is a module operated in a demon manner to transfer the basic tag event data to the application system at a real time, which wants information customized by the outside. The tag data from the basic tag event generator 71 is first stored in a buffer 76 and passed for predetermined data filtering and to transfer resulted data to the application system by bypassing a processor 73. The processor 73 is comprised of an event filter 74 and a real time event data deliver 75. Meanwhile, the tag data from the basic tag event generator 71 is first stored in the event buffer 76 and then stored in the short-term nonfiltered tag event data storage unit 113 of FIG. 6 by an event data writer 77.

The processor 73 is operated in the demon manner based on the router flow definition defined by an event data handler management module 78 and an event data process router flow definition module 79, and transfers information to the relevant application system in the push mode at a real time.

An event data process router flow definition module 79 is a management module which is capable of describing, in a customizable format, a series of flows such as selection of proper data filters and the front and rear connection between them, and until transfer to final real time process application system, via an external interface, according to the relevant domain and the real time process application system. This depends on the form of user interface describing a graph or router flowchart.

Secondly, the filtered tag event data processor 112 will be described below with reference to FIGS. 6 and 9. FIG. 9 is a detailed configuration diagram of the filtered tag event data processor 112 shown in FIG. 6 in accordance with the invention.

The filtered tag event data processor 112 is a system where it supports the pull type structure for getting the filtered tag lists during a desired term, at a time when each application system wants. It registers an individual application system listener, that is, destination information to get it via an application system listener register 901, format information, etc., and gets a corresponding listener ID.

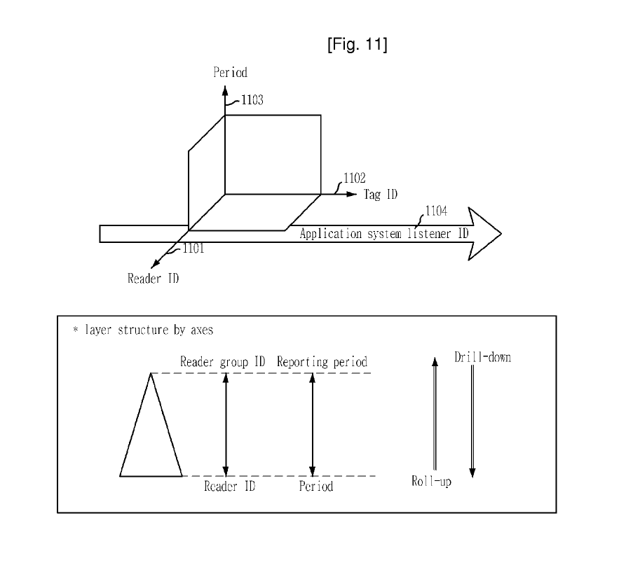

A filtered event tag data generation scheduler demon 903 as background of the processor 112 periodically extracts tag data stored in the short-term nonfiltered tag event data storage unit 113 (FIG. 6) by periods according to the procedure shown in FIG. 10; and properly processes, stores and manages the same in a filtered tag event list information storage unit 906 having a multi-dimensional data storage structure as in FIG. 11. That is, the filtered event tag data generation scheduler demon 903 stores and manages tag lists recognized by tags, readers, according to periods more than one times.

When the specific application system requests the filtered tag lists during a fixed term, an application system request acceptor 902 accepts the request and requests a handler 905 managed by an application system request handler pool 904 to handle the request.

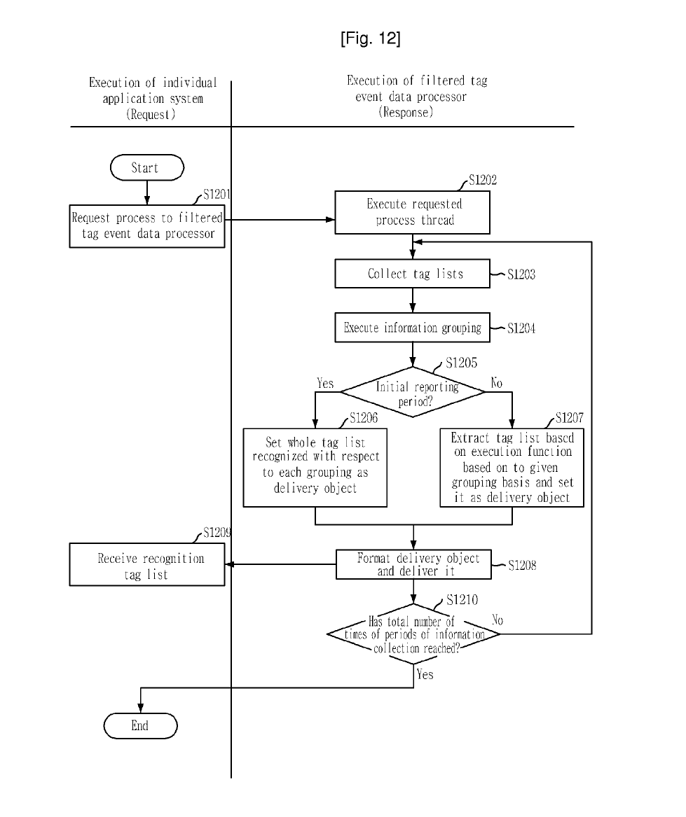

The application system request handler 905 creates filtered data of form suitable for the request, according to the procedure shown in FIG. 12, using the data stored in the filtered tag event list information storage unit 906 that are created by periods by the filtered event tag data generation scheduler demon 903, and then transfers the result to the requested application system. The application system request handler 905 returns to the application system request handler pool 904 to go to the standby state as soon as the process has been completed.

Thirdly, a tag data migration processor (handler) 114 of FIG. 6 will be given below. The tag data migration processor prevents the continuous data increase of the short-term nonfiltered tag event data storage unit 113 that stores the short-term non-filtered data; and migrates the tag data at a constant interval to use it as the future history information.

Meanwhile, the RFID event management component 110 firstly performs a data filtering function and secondly an event transfer function. These functions are already described, but details thereof will be described below.

Firstly, the data filtering function will be provided.

The RFID system serves to filter and rout the event data transmitted from the RFID reader prior to transferring it to the application system. The present invention relates to a filtering function that filters the event data to be provided by the RFID system. This is applied in properly filtering tag event data flowing from the reader shown in FIG. 6.

1. Redundancy Removing Filter of RFID Reader Recognition Event Data

(1) In case where one RFID continuously recognizes same tag several times, the basic tag event generator 71 filters such doubly recognized tag to some degree.

However, there may sometimes be an instance where such redundancy is not solved by only the creation of the basic tag event. In consideration with this case, the present invention provides filters as follows.

1) When the object to which the rapidly moving tag is attached is recognized, if the tag recognition range escape time is short, the created event data will be continuously transferred. At this time, if a filter is provided to have only firstly transferred event data remained and lastly transferred event data among event data transferred during a fixed term T, the application system may calculate a time during the tag holds within the recognition range of the reader to use such information. This is processed in the sequence as shown in FIG. 14.

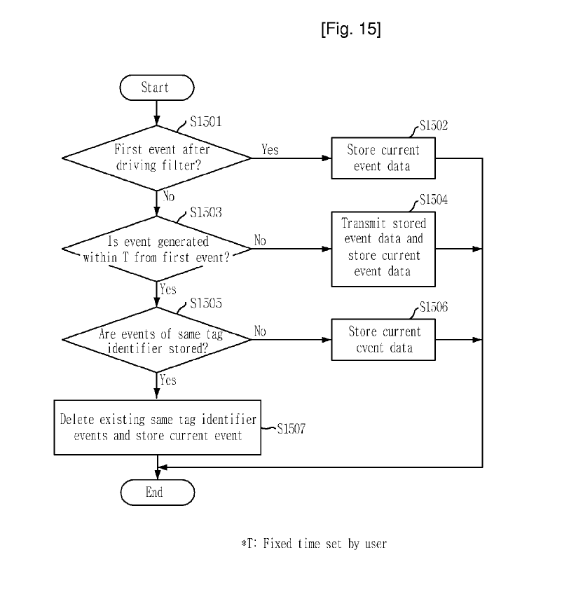

2) Among the doubly occurred same tag identifier events during the fixed time T, only the most recently recognized one event during the fixed time T is transferred to remove the redundancy. And, the instance where tag decision recognition events are continuously flowed from the reader is considered. This filter may be used when seeking the most recent event among the same tag identifier events. This is processed in the sequence as shown in FIG. 15.

(2) In case where other RFID readers recognize same tags, if a plurality of readers connected to one RFID system doubly recognizes the same tags, the filter can filter by comparing tag identifier values assigned to the readers based on the readers' identifiers basically.

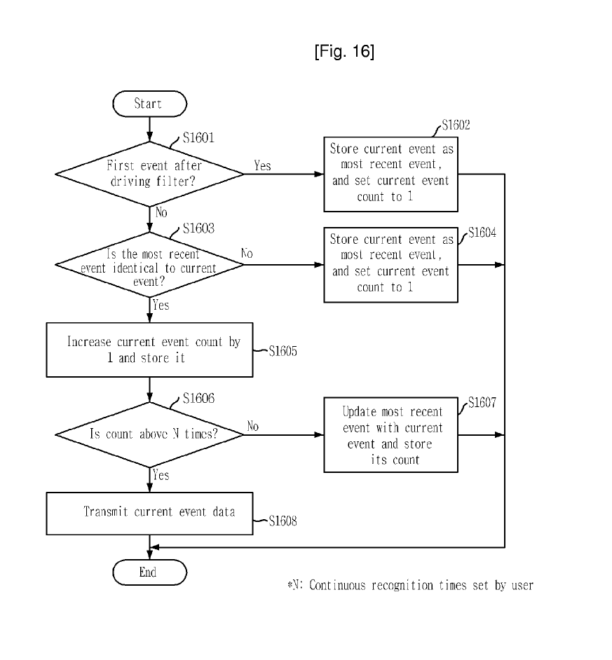

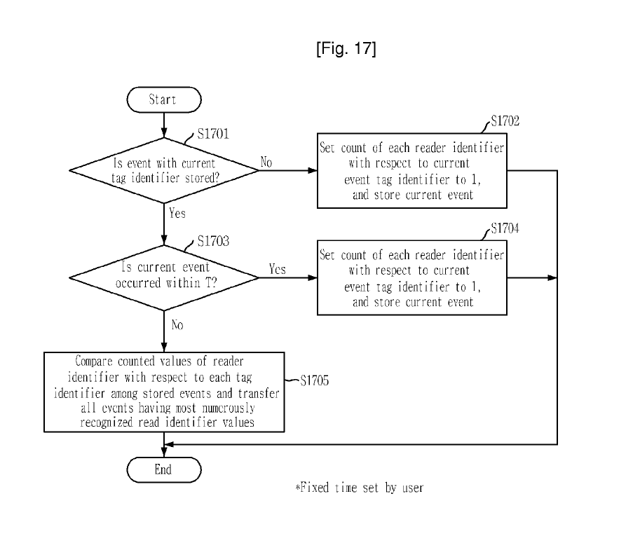

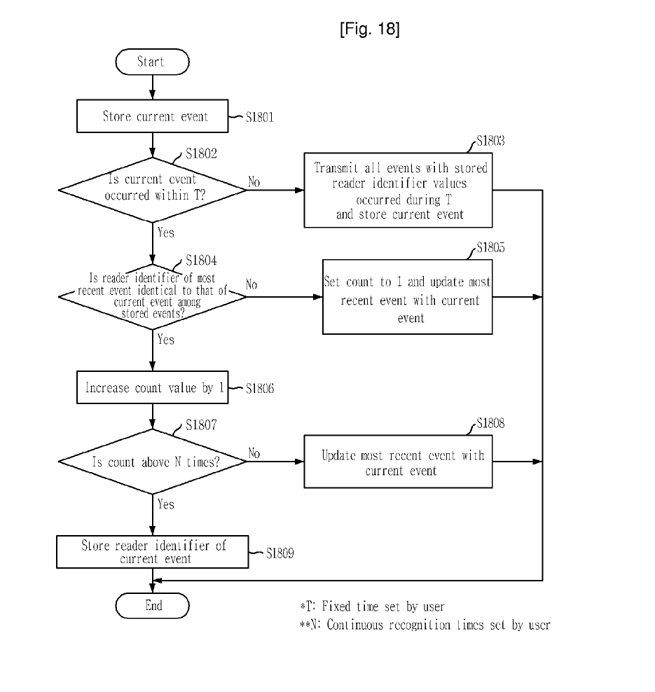

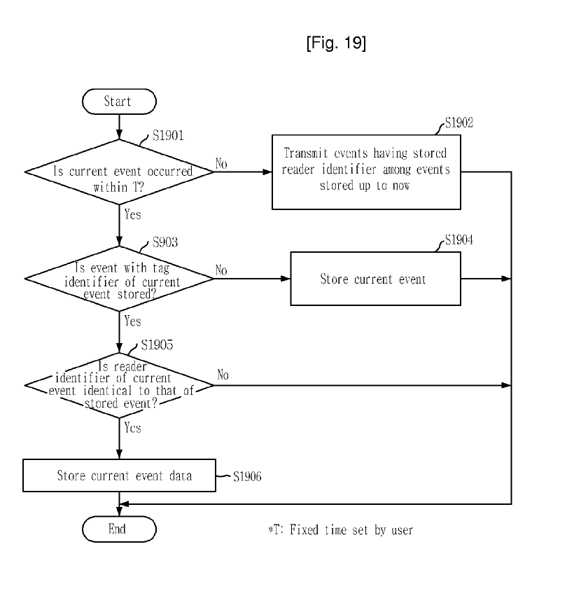

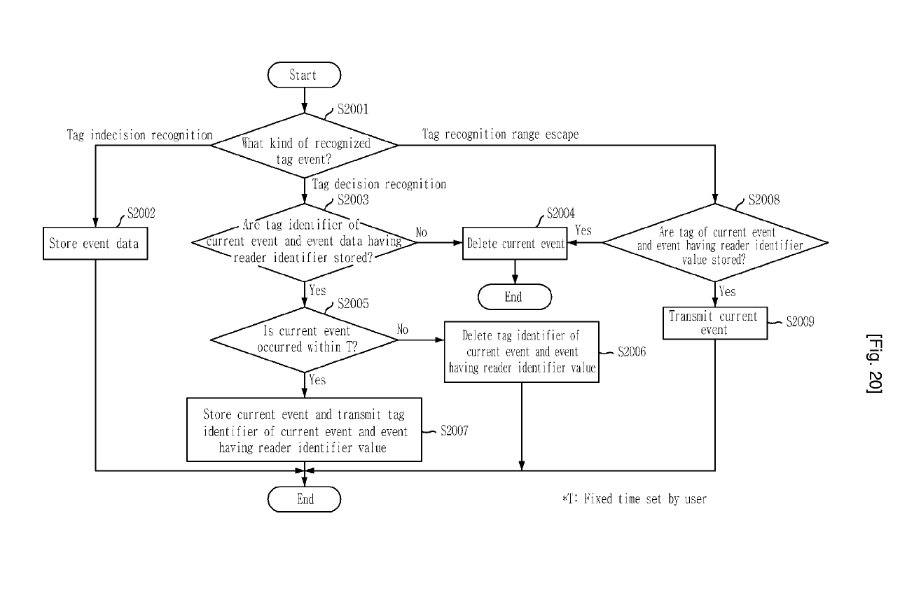

If such information is not satisfied, the following methods may be used. Specifically, in case where the event data for the same tags are recognized as the identifier values of the readers, 1) when the reader of the same reader identifier recognizes a specific tag more than N times, its event data is valid. This is processed in the sequence of FIG. 16. 2) The reader identifiers of event data having same tag identifier values recognized during the fixed time T are counted and the most numerously recognized readers are valid. And, the events having the valid reader identifiers recognized during T are all transferred. This is processed in the sequence shown in FIG. 17. 3) When the events having the same reader identifiers are continuously transferred more than N times during the fixed time T, the relevant readers are valid. At this time, the values of the tag identifiers are not considered. All the events having the relevant reader identifiers recognized during T are transferred. This is processed in the sequence as shown in FIG. 18. 4) Priority is given to the firstly recognized reader, out of the events of the same tag identifiers recognized by the readers during the fixed time T. This is processed in the sequence as shown in FIG. 19. 5) The filtering is made based on the event type of the event data having other reader identifiers of the same tag identifiers.

If no decision recognition state event is taken place during a fixed time after the occurrence of the tag indecision recognition events, the tag indecision recognition events are removed.

If all the tag decision recognition events are taken place, the firstly occurred tag recognition range escape events are removed when another tag recognition range escape event is not occurred within the fixed time from the firstly occurred tag recognition range escape events among the same tag identifiers.

If the tag decision recognition and the tag recognition range escape events are all occurred, the filtering is made according to the priority given strategically. There may be various methods for giving the priority. For example, the priority may be given to the firstly recognized events or specific reader.

The above methods are processed in the sequence as shown in FIG. 20.

2. RFID Reader Recognition Error Removing Filter by RF Radio Wave Interference, Reflection, etc., Generated by Peripheral Environments

1) In case where RFID reader does not recognize tag existing within a range where RF radio wave is transferred by influence of peripheral environments, this problem is solved by applying the event creation state transition (see FIG. 8) provided by the basic tag event generator 71.

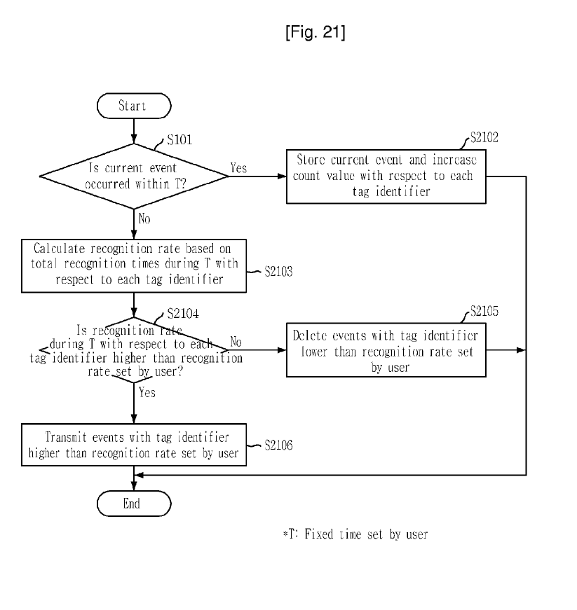

2) In case where RFID reader recognizes tag existing outside an expected transfer area of RF radio wave by influence of peripheral environments, the recognition rate of tag recognized during the fixed term T is calculated and the relevant event data are removed if the recognition rate is lower than a recognition rate set by the user. This is processed in the sequence as shown in FIG. 21.

Secondly, the event transfer function will be explained below. The event transfer is made by two modes: the push mode and the pull mode.

First of all, as described above, the push structure registers filters required by the relevant domain via the event process management module 78 shown in FIG. 7, sets filters required by domains via the event process router flow definition module 79 and the front and rear connection between the filters, and defines a series of flows for transferring the filtered result to the application systems hoping the real time process. According to the defined flows as noted above, the tag data flowing from the reader at the real time are transferred to the application systems registered in one direction via the demon processor of the basic tag event generator 71 and the tag data process router demon 72.

Thereafter, the process flowcharts illustrating detailed functions of the pull structure are shown in FIGS. 10 and 12. FIG. 10 represents a flowchart showing the role of the filtered event tag data generation scheduler demon 903 that generates the basic data of the pull structure.

The filtered event tag data generation scheduler demon 903 selects information stored in the nonfiltered tag data storage unit by certain periods defined by the system or user, extracts tag data list regarded as “decision recognition state” during that period by each reader at step S1001, creates the filtered event data, and stores and manages it in the form of multi-dimensional data model at step S1003, as shown in FIG. 11.

Each axis is made in multi-layer manner. For example, a reader axis is consisted in such a manner that a separate reader ID is at the lowest end and a reader group is at the upper end. This multi-dimensional and multi-layer tag data list storage structure enables the applying of the widely known OLAP function, thereby promptly and precisely providing the pull service.

At step S1003, it should be noted that since information is not unlimitedly stored, it should need to set the limitation of the number of times of periods that is allowed for the maximum storage, and to remove from the most preceding records when the limitation is over. This removes the records corresponding to the removal object periods at the period axis by applying Slice & Dice function, in view of OLAP.

FIG. 12 is a flowchart illustrating one embodiment of a request and response method for the filtered tag event data in the RFID event management component in accordance with the invention. FIG. 12 describes a procedure (the pull mode) for the relevant application system to get the tag event data lists during a fixed term under the assumption that external application system hoping the use of tag event data already has information such as destination and transfer data format (for example, DTD of PML) and listener having registered binary files, and gets the listener ID thereon.

Firstly, referring to FIG. 12, the application system requests an event handler to handle the event together with the following information at step S1201. When it directly requests the event handler, the information to be transferred together includes: total reporting period (the notice on the information during desired number of times of periods based on the period provided by the scheduler demon), application system reporting period (the number of times of periods on the transfer of data to application system every some periods in the total number of times of run periods), grouping basis (the basis on whether the tag lists are grouped by readers or reader groups), tag list type basis (operation) upon transfer (whether the recognized total lists are transferred by the application system reporting periods, or only added or removed lists are transferred via a comparison of the previously transferred lists), result format (designated in the transfer form of the tag lists created by the grouping basis and tag list form basis, e.g., PML, application system listener ID (listener ID given by the request of the application system), and so on.

When the request to the event handler is made with the information as mentioned above at step S1201, one handler is assigned to handle the request. The assigned handler creates the tag lists, in harmonization with the grouping basis and tag list form basis by the application system reporting periods, based on the tag lists stored in the filtered tag event list information storage unit, and then transfers the same to the application system. This transferring is continued until the given total reporting period.

FIG. 8 shows one embodiment of the state transition for the basic tag event generation in the RFID event management component in accordance with the invention, which represents the state transition view showing 3 states and 6 events.

A basic concept is that since the RFID reader does not support the tag recognition of 100%, a plurality of states are defined and transited based on several bases; and finally it is regarded as “one tag was recognized” only when it reaches the “decision recognition state.”

The basis for deriving the transition between the states depends on the number of times of tags recognized during a certain term from the recent recognition point of time, that is, count and timeout.

In the states as shown in the figure, the state information by tags recognized by one reader is defined and managed.

Firstly, the states will be described below. An “unknown state” 80 implies an instance with no recognition. When initially recognized by the reader, once it is transited to “indecision recognition state” 81, indicating a state which does not have the reliability of 100% although recognized by the reader. That is, this is because there is an instance where the tag that should not be read by external reasons may be read out. A “decision recognition state” 83 indicates a state where one tag has been correctly recognized by a relevant reader.

Subsequently, an explanation will be given with respect to the events for state transitions.

A “tag indecision recognition” 810 implies the time when the relevant tag is initially recognized from the reader, and a “tag indecision recognition state continuation” 802 means an instance, which does not satisfy the requirement for transiting to the decision recognition state although recognized by the reader.

A “tag recognition invalid regard” 803 represents an instance where tag could not be recognized within a fixed interval from the recent “indecision recognition state” point of time, wherein this instance is not regarded that the tag is recognized.

A “tag decision recognition” 804 indicates an instance transited when recognized by the fixed number of times within the fixed interval from the point of time transited to the initial tag recognition state. The fixed interval and number of times are defined by the exterior according to circumstances and are reference values for regarding as 100% recognition.

A “tag decision recognition state continuation” 805 implies a state that the decision recognition state is continued.

A “tag recognition range escape” 806 represents an instance where tag recognition information is no longer transferred within the fixed interval from the recent tag decision recognition state. This is an event that it is regarded that the tag escapes from the recognition range of the reader.

Hereinafter, details of each of FIGS. 10 to 21 will be given below.

FIG. 10 is a flowchart illustrating one embodiment of a periodic process method of the filtered event tag data generation scheduler demon shown in FIG. 9 in accordance with the invention.

At step S1001, the process extracts tag lists that belong to the “decision recognition state” by readers; and removes, at step S1002, doubled tags among the extracted tag lists, and decides tag lists recognized by each reader with respect to each period.

Thereafter, the tag lists are stored in the filtered tag event list information storage unit by the readers at step S1003. By designating the maximum number of times of storage periods, the tag lists may be removed in the order of preceding periods when passing the designated maximum number of times.

The processes as described above are repeatedly performed every period.

FIG. 11 is a view explaining one embodiment of a method for storing the filtered event tag list information in the RFID event management component in accordance with the invention.

Basically, the data is stored according to the multi-dimensional database, e.g., Hyper-Cude Model, structure that is composed of four axes, that is, reader ID 1101, tag ID 1102, period 1103, and application system listener ID 1104. Each axis may be made in the multi-layer manner to thereby apply Online Analytical Processing (OLAP) technique.

Each axis may be constituted in the multi-layer manner. For example, the reader axis is consisted of the separate reader ID at the lowest end and the reader group ID at the upper end. This multi-dimensional and multi-layer tag data list storage structure can quickly and precisely provide the pull services by readily applying the OLAP function that is widely known in the art.

FIG. 12 is a flowchart illustrating one embodiment of a method for a request and response of the filtered tag event data in the RFID event management component in accordance with the invention.

When a separate application system requests the filtered tag event data processor 112 of FIG. 6 and FIG. 9 to handle the request at step S1201, the request handler pool 904 within the filtered tag event data processor accepts the request and seeks one request handler thread 905 presenting in the request handler pool 904 at step S1202.

And then, the filtered tag event data processor collects information based on the tag lists stored in the filtered tag event list information storage unit by the readers with respect to each period until reaching one reporting period at step S1203, and groups the collected information depending on the given grouping basis, for example, by readers, reader groups, patterns of tag ID, etc., at step S1204.

Next, the process judges whether it has reached the first reporting period out of the total reporting periods at step S1205.

After the judgment, the process determines the total tag lists, which are the tag lists by the groups, collected during the present reporting period at the first reporting period as the objects to be transferred at step S1206.

If it is judged that there is not the first reporting period, the process determines the objects to be transferred based on an execution function given through the comparison of the tag lists collected during the immediately previous reporting period and the tag lists collected during the current period at step S1207. The execution function may be one of (a) the total collected tag lists, (b) the tag lists added to the previous period, (c) the tag lists excluded from the previous period, and (d) one of the tag lists added or excluded to or from the previous period.

Thereafter, the process performs the formatting with respect to the tag lists by groups determined through step S1206 or S1207 on the basis of the given formatting method at step S1208, and then transfers the tag lists to the requester (application system) corresponding to the application system listener ID using plural manners, e.g., HTTP/POST, SOAP, DB, etc., at step S1209.

At a next step S1210, the process judges whether it has reached the number of times of total reporting periods. If not reached yet, the processes following the above step S1203 are repeatedly performed.

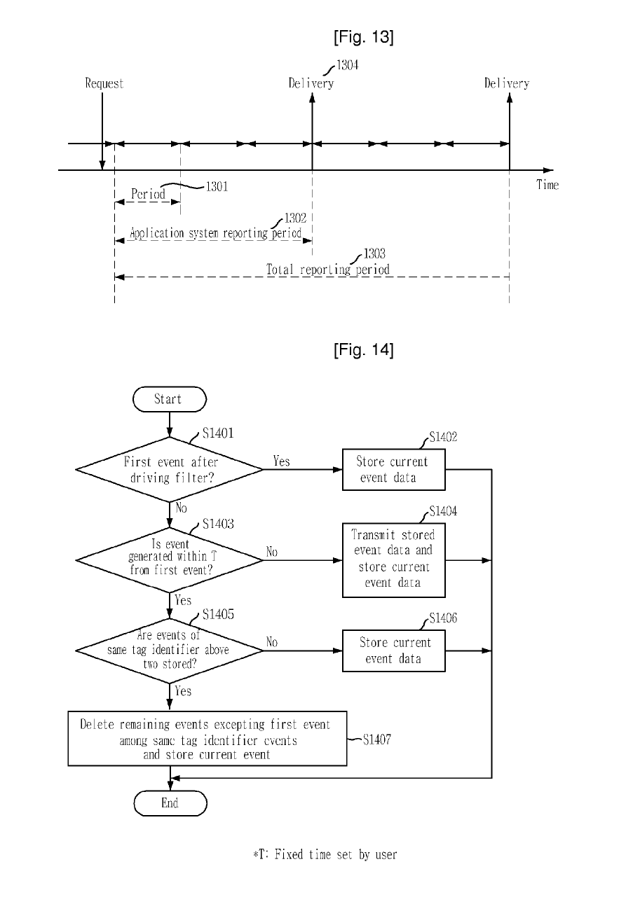

FIG. 13 is a view describing a required factor when requesting to the filtered tag event requester in the RFID event management component in accordance with the invention.

A ‘period’ 1301 is a period, e.g., 1000 ms, during which the filtered event tag data generation scheduler demon 903 creates the filtered tag lists, which depends on the period of scheduler demon.

A ‘application program reporting period’ 1302 indicates the number of times of periods to get the filtered tag lists from the event handler upon request by each application system, wherein it is set to twice the ‘period’ given at the period 1301, for example, 3× period.

A ‘total reporting period’ 1303 is a total period from the point of time hoping the reception of reporting to the final point of time, which is set to twice the ‘application system reporting period’ 1302, for example, 2× application system reporting period.

A ‘transfer’ 1304 transfers, every application system reporting period, the result obtained by performing the given grouping basis and operation with respect to the tag lists collected during the above processes every application system reporting period to the application system corresponding to the application system listener ID requesting the result.

Hereinafter, the meaning of “removal,” “storage” and “transfer” used in the explanation of FIGS. 14 to 21 is as follows. The “Removal” implies removing the relevant events from the temporal storage unit storing them, and the “transfer” means transferring the relevant events to other event filters connected to the current event filter, application system, or the like. The “Storage” stands for storing the events created during the filtering algorithm execution in the temporal storage unit. Further, the events' storage, removal, and transfer correctly imply storing, removing and transferring the event data, rather than the events.

FIG. 14 is a flowchart illustrating one embodiment of a double recognition removal filtering method in accordance with the invention, wherein how to extract first and final events among the same tag identifier events taken place during a fixed term is provided.

At a first step S1401, referring to FIGS. 6 and 7, the process judges whether the currently recognized event is the event firstly occurred after a driving of the event filter within the basic tag event data processor and router 111. If that is the first event, the process stores the current event data at step S1402, and if otherwise, the process again checks at step S1403 whether the recognized event is the one created during the term from the first event to the time T set by the user.

If it is checked that the currently recognized event is not the one created during the term from the first event to the time T set by the user, the process transfers the event data stored up to now, and stores the currently recognized event data at step S1404. However, if the currently recognized event is the one created during the term from the first event to the time T set by the user, the process again confirms at step S1405 whether there are stored more than two same tag identifier events as the currently recognized event.

From the confirmation, if more than two are not stored, the process stores the currently recognized event data at step S1406. If more than two are stored, the process removes the remaining events excluded from only the initial event among the events having the same tag identifier as the currently recognized event data, and stores the current event to have only the most recent event remained with respect to the same tag identifiers.

FIG. 15 is a flowchart illustrating one embodiment of a double recognition removal filtering method in accordance with the invention, wherein how to extract the most recent events among the same tag identifier events occurred during a fixed term is presented.

At a first step S1501, the process judges whether the currently recognized event is the event firstly raised after a driving of the event filter within the basic tag event data processor and router 111, with reference to FIGS. 6 and 7. If that is the first event, the process stores the current event data at step S1502, and if otherwise, the process again checks at step S1503 whether the recognized event is the one created during the term from the first event to the time T set by the user.

If it is checked that the currently recognized event is not the one created during the term from the first event to the time T set by the user, the process transfers the event data stored up to now, and stores the currently recognized event data at step S1504. However, if the currently recognized event is the one created during the term from the first event to the time T set by the user, the process again confirms at step S1505 whether there are stored the same tag identifier events as the currently recognized event.

In the confirmation, if not stored, the process stores the currently recognized event data at step S1506. If stored, the process removes the previously stored events having the same tag identifier as the currently recognized event data and stores the current event at step S1507.

FIG. 16 is a flowchart illustrating one embodiment of plural readers adjusting filtering method in accordance with the invention, which shows a method for extracting the reader events continuously recognized above several times with respect to the same tags.

At a first step S1601, the process judges whether the currently recognized event is the event firstly happen after a driving of the event filter within the basic tag event data processor and router 111 of FIGS. 6 and 7. If that is the first event, the process stores the currently recognized event as the most recent event and sets the count value of the current event to 1 at step S1602. Otherwise, the process compares the tag and reader identifier of the most recent event with those of the currently recognized event at step S1603.

In the comparison, if the tags and reader identifiers are not identical to each other, the process stores the currently recognized event, which is current event, as the most recent event and sets the count value of the current event to 1 at step S1604.

However, if the tags and reader identifiers are identical, the process increases the count value of the current event by 1 and stores the current event at step S1606. After that, the process confirms whether the counted value of the current event is above the number of continuously recognized times set by the user at step S1606.

In confirmation, if the count value of the current event is not above the number of continuously recognized times set by the user, the process updates the most recent event with the current event and then stores the count value at step S1607.

If the count value of the current event reaches the number of continuously recognized times set by the user, the process transfers the current event data step S1608.

FIG. 17 is a flowchart illustrating one embodiment of plural readers adjusting filtering method in accordance with the invention, wherein how to extract the most numerously recognized readers is provided.

Firstly, at step S1701, the process judges whether there was stored the events having the same tag identifiers as the currently recognized event.

If it is judged that there was not stored the events having the same tag identifiers, the process sets the count value to 1 with respect to the tag identifier of the current event and its reader identifier and stores the current event at step S1702.

However, if it is judged that there was stored the events having the same tag identifiers, the process confirms whether the current event was taken place during the time T set by the user at step S1703.

If there is still the current event taken place within the time T set by the user, the process increases the count value by 1 by reader identifiers with respect to the tag identifier of the current event and stores the current event at step S1704.

If the time set by the user has expired, the process compares the count values of the reader identifiers associated with each tag identifier among the stored events and transfers all the events having the most numerously recognized reader identifiers at step S1705.

FIG. 18 is a flowchart illustrating one embodiment of plural readers adjusting filtering method in accordance with the invention, which extracts the reader events continuously recognized above several times regardless of the tag identifiers.

First of all, the process stores, at step S1801, the currently recognized event, and judges, at step S1802, whether the currently recognized event was occurred during the term T set by the user.

If it is judged that the time set by the user has expired, the process transfers all the events having the reader identifier values to be transferred among the events occurred and stored during T, and stores the currently recognized event at step S1803.

In the confirmation, if the recognized event is during T, the process compares the reader identifier of the most recent event among the stored events with that of the current recognized event at step S1804.

As result of the comparison, if the reader identifiers are not identical, the process sets the count to 1, and updates the most recent event among the stored events with the current event at step S1805.

However, if the reader identifiers are identical, the process increases the count by 1 at step S1806, and confirms whether the count value is above the continuous recognition number of times N set by the user at step S1807.

If not above N, the process updates the most recent event with the current event and then stores the same at step S1808. However, if above N, the process stores the reader identifier of the current event as the reader identifier to be transferred at step S1809.

FIG. 19 is a flowchart illustrating one embodiment of plural readers adjusting filtering method in accordance with the invention, wherein how to extract the initially recognized reader event with respect to the same tags is provided.

First of all, at step S1901, the process judges whether the currently recognized event was occurred during the term T set by the user.

If it is judged that the time T set by the user has expired, the process transfers the events having the stored reader identifier values among the events stored until now at step S1902.

In the judgment, if the currently recognized event is taken place during T, the process confirms whether there was stored the event having the tag identifier value of the currently recognized event at step S1903.

If it is confirmed that there was not stored the event having the tag identifier of the current event, the process stores the current event at step S1904.

However, if there was stored the event having the tag identifier of the current event, the process again judges whether the reader identifier of the current event is the same as that of the stored events at step S1905.

If it is judged that the reader identifier of the current event is the same as that of any of the stored events, the process stores the current event data at step S1906, and simply ends if the reader identifier of the current event is not the same as that of any of the stored events.

FIG. 20 is a flowchart illustrating one embodiment of plural readers adjusting filtering method in accordance with the invention, which is based on the type of the events.

At a first step S2001, the process judges the type of the currently recognized event.

If it is judged that the type of the currently recognized event is “tag indecision recognition,” the process stores the event data at step S2002.

If it is judged that the type of the currently recognized event is “tag decision recognition,” the process confirms whether there was stored the same event data as the tag identifier and reader identifier of the current event at step S2003. If stored, the process removes the current event at step S2004; and if not stored, the process confirms whether the current event is taken place during T set by the user at step S2005.

In the confirmation, if the current event is taken place during T, the process stores the current event, and transfers the events having the tag identifier and reader identifier of the current event among the stored events at step S2007.

However, if the time T set by the user has expired, the process removes the event having the tag identifier and reader identifier of the current event at step S2006.

Further, if the current event is escaped from the tag recognition range, the process confirms whether there was stored the event having the tag and reader identifier value of the current event at step S2008.

If it is confirmed that if there was stored the event having the tag and reader identifier of the current event, the process transfers the current event at step S2009; and if there was not stored the event having the tag and reader identifier value of the current event, the process removes the current event at step S2004.

FIG. 21 is a flowchart illustrating one embodiment of an RFID reader recognition error removal filtering method in accordance with the invention, which represents the plural readers adjusting filtering method based on the recognition rate.

First of all, at step S2101, the process judges whether the currently recognized event was occurred during the term T set by the user.

If it is judged that the currently recognized event is taken place during T, the process stores the current event and increases the count of the event by tag identifiers of the event at step S2102.

However, if the currently recognized event is taken place after the term T, the process calculates a recognition rate by tag identifiers based on the total recognition number of times occurred during T set by the user at step S2103.

Subsequently, the process judges whether the recognition rate during T computed by tag identifiers is above the recognition rate set by the user at step S2104.

From the judgment, if the recognition rate during T computed by tag identifiers is not above the recognition rate set by the user, the process removes the events of tag identifiers that are under the recognition rate set by the user at step S2105.

However, if the recognition rate computed by tag identifiers is above the recognition rate set by the user, the process transfers the relevant events at step S2106.

The method of the present invention as mentioned early may be implemented by a software program and stored, in a computer-readable manner, in storage medium such as CD-ROM, RAM, ROM, floppy disk, hard disk, optical magnetic disk, etc. This process may be easily carried out by those skilled in the art; and therefore, details of thereof are omitted here.

The present application contains subject matter related to Korean patent application No. 2004-0108845, filed with the Korean Intellectual Property Office on Dec. 20, 2004, the entire contents of which are incorporated herein by reference.

While the present invention has been described with respect to certain preferred embodiments, it will be apparent to those skilled in the art that various changes and modifications may be made without departing from the scope of the invention as defined in the following claims.

1. A Radio Frequency Identification (RFID) reader interface apparatus for multi-protocol based heterogeneous reader support for providing an interface between RFID readers and application systems, the apparatus comprising:
a reader connection management means for identifying a plurality of RFID readers separately and establishing a connection between the RFID readers and the application systems;
a reader transmission/reception process means for receiving tag data from the RFID readers or sending application system data to be converted into individual protocol data at a protocol process means to the corresponding RFID readers;
the protocol process means for converting the tag data received by the reader transmission/reception process means into common protocol data or application system data received by a middleware transmission/reception process means into the individual protocol data, to support the heterogeneous RFID readers; and
the middleware transmission/reception process means for sending the tag data converted into the common protocol data at the protocol process means to the application systems or an RFID event management device, or receiving the application system data from the application systems.

2. The apparatus as recited in claim 1, further comprising a monitoring means for monitoring a connection operation of the reader connection management means, a connection state between the RFID readers and the application systems, and a data transmission/reception at the reader transmission/reception process means and the middleware transmission/reception process means.

3. The apparatus as recited in claim 2, wherein the monitoring means performs a notice message generation and a log record and then feedbacks to the corresponding RFID reader when a problem takes place during the execution of the monitoring function.

4. The apparatus as recited in claim 1, further comprising a command/response exchange means for carrying out a feedback to the reader transmission/reception process means with respect to command/response data suitable for processing at other readers, among the data to be transmitted from the middleware transmission/reception process means to the application systems or the RFID event management device, for direct mutual data exchange between the RFID readers.

5. The apparatus as recited in claim 1, wherein the reader connection management means includes:
a reader profile management means, when newly connecting an RFID reader, for confirming, storing and managing a profile of the RFID reader;
a reader identifier issuance means for identifying the RFID reader based on its IP address while reading system information of the RFID reader, and issuing a reader identifier to the identified RFID reader; and
a connection management means for establishing a connection between the RFID reader and the application systems using the reader identifier.

6. The apparatus as recited in claim 5, wherein the protocol process means comprises:
a parsing means for parsing the tag data received through the reader transmission/reception process means;
a protocol interface/process means for converting the tag data created according to an individual protocol every RFID reader into common protocol data, or application system data prepared according to common protocol into individual protocol data;
a reception buffering means for temporarily storing the tag data from the protocol interface/process means to provide the data to the application systems;
a transmission buffering means for temporarily storing the application system data received by the middleware transmission/reception process means to enable the protocol conversion at the protocol interface/process means; and
a message generation means for generating a transmission message to be sent from the application system data provided from the protocol interface/process means to the corresponding RFID reader.

7. An RFID event management apparatus for multi-protocol based heterogeneous reader support for managing events created from RFID readers, the apparatus comprising:
a basic tag event data process and routing means for generating and filtering basic tag event data corresponding to a transition between certain states among tag data provided from the outside to route filtered basic tag event data to a corresponding application system; and
a nonfiltered tag event data storing means for storing the basic tag event data.

8. The apparatus as recited in claim 7, further comprising a filtered tag event data process means for extracting the basic tag event data stored in the nonfiltered tag event data storing means by periods and creating filtered tag event data of form corresponding to a request of the application system to provide the same to the application system.

9. The apparatus as recited in claim 8, wherein the filtered tag event data process means comprises:
an application system listener registration means for receiving and registering listener from the application system individually and giving a listener ID to the registered application system;
a filtered event tag data generation scheduling means for extracting the tag event data stored in the nonfiltered tag event data storing means by periods, and storing and managing it as filtered tag event list information having a multi-dimensional data storing structure;
a filtered tag event list information storing means for storing the filtered tag event list information;
an application system request acceptance means for delivering a request from the application system to an application system request process means, or a process result from the application system request process means to the application system; and
the application system request process means for creating filtered tag data of form in coincidence with a request of the application system based on the filtered tag event list information stored in the filtered tag event list information storing means, and sending the same to the application system request acceptance means.

10. The apparatus as recited in claim 9, wherein the filtered event tag data generation scheduling means stores/manages tag lists identified by periods, tags, and readers as the filtered tag event list information.

11. The apparatus as recited in claim 9, wherein the storing process of the filtered tag event list information in the filtered event tag data generation scheduling means stores the data according to the multi-dimensional database (Hyper-Cude Model) structure that gives reader ID, tag ID, period, and application system listener ID as axes, each axis having a multi-layer form.

12. The apparatus as recited in claim 9, wherein the request of the application system request acceptance means includes at least one of grouping basis, total reporting period, application system reporting period, tag list form basis upon delivery, result format, and application system listener ID.

13. The apparatus as recited in claim 7, further comprising a tag data migration process means for preventing a continuous data increase to the filtered tag event data storing means, and migrating tag data every a preset interval to use as history information.

14. The apparatus as recited in claim 7, wherein the basic tag event data process and routing means includes:
a basic tag event generation means for creating basic tag event data corresponding to a transition between certain states, among tag data provided from the outside;
an event filtering means for performing a preset data filtering with respect to the basic tag event data;
an event data delivery means for transferring event data filtered by the event filtering means in a push mode at a real time; and
an event data record means for storing the basic tag event data in the non-filtered tag event data storing means.

15. The apparatus as recited in claim 14, wherein the state transition in the basic tag data generation means includes tag indecision recognition event, tag indecision recognition state continuation event, tag recognition invalid regard event, tag decision recognition event, tag decision recognition state continuation event, and tag recognition range escape event.

16. The apparatus as recited in claim 14, wherein the data filtering process in the event filtering means extracts only initially recognized event data and lastly recognized event data, among same tag identifier events occurred during a preset time, in case where one RFID reader doubly recognizes a same tag.

17. The apparatus as recited in claim 14, wherein the data filtering process in the event filtering means extracts only most recent event data, among same tag identifier events occurred during a preset time, in case where one RFID reader doubly recognizes a same tag.

18. The apparatus as recited in claim 14, wherein the data filtering process in the event filtering means extracts continuously recognized event data above several times with respect to a specific tag having same reader identifiers in case where a plurality of RFID readers doubly recognize a same tag.

19. The apparatus as recited in claim 14, wherein the data filtering process in the event filtering means extracts event data having most numerously recognized reader identifiers, among event data same tag identifiers recognized during a preset time, in case where a plurality of RFID readers doubly recognize a same tag.

20. The apparatus as recited in claim 14, wherein the data filtering process in the event filtering means extracts event data having same reader identifiers continuously recognized above a predetermined number of times during a preset time, without considering tag identifier, in case where a plurality of RFID readers doubly recognize a same tag.

21. The apparatus as recited in claim 14, wherein the data filtering process in the event filtering means extracts event data having reader identifiers initially recognized with respect to events having same tag identifiers recognized during a preset time in case where a plurality of RFID readers doubly recognize a same tag.

22. The apparatus as recited in claim 14, wherein the data filtering process in the event filtering means filters event data based on a type of event data having different reader identifiers, among event data having same tag identifiers, in case where a plurality of RFID readers doubly recognize a same tag.

23. The apparatus as recited in claim 14, wherein the data filtering process in the event filtering means calculates a tag recognition rate during a predetermined time and extracts event data belonging to the range that the tag recognition rate is above a recognition rate set by a user in case where the RFID reader recognizes a tag outside an expected delivery area of radio frequency by peripheral environment.

24. An RFID reader interface method for multi-protocol based heterogeneous reader support for providing an interface between RFID readers and application systems, the method comprising the steps of:
a) identifying a plurality of RFID readers separately, giving a reader identifier to each RFID reader, and establishing a connection between the RFID readers and the application systems using the reader identifiers;
b) after the connection is established at the step a), receiving tag data from the RFID readers or sending application system data to be converted into individual protocol data at step c) below to the RFID readers;
c) converting the tag data created in accordance with individual protocol every RFID reader into common protocol data or application system data prepared in accordance with common protocol into the individual protocol data, to support the heterogeneous RFID readers; and
d) after the connection is established at the step a), sending the tag data converted into the common protocol data at the step c) to the application systems or an RFID event management device, or receiving the application system data from the application systems.

25. The method as recited in claim 24, further comprising a step of: e) monitoring a connection process in the step a), a connection state between the RFID readers and the application systems, and data transmission/reception at the steps b) and d).

26. The method as recited in claim 24, further comprising f) exchanging data for direct communication between the RFID readers.

27. The method as recited in claim 24, wherein the step c) comprising the steps of:
c1) parsing the tag data received from the step b);
c2) converting the parsed tag data into common protocol data, or application system data from the step d) into individual protocol data;
c3) generating a transmission message to be sent from the application system data provided from the step c2) to the corresponding RFID reader.

28. An RFID event management method for multi-protocol based heterogeneous reader support for managing events created from RFID readers, the method comprising the steps of:
a) creating basic tag event data corresponding to a transition between preset states out of tag data provided from the outside;
b) performing a filtering with respect to the basic tag event data created at the step a); and
c) delivering tag event data filtered at the step b) to the corresponding application system using a push mode.

29. The method as recited in claim 28, further comprising d) extracting the basic tag event data by periods and creating filtered tag data of form corresponding to a request of the application system to provide the same to the application system.

30. The method as recited in claim 28, wherein the step b) or d) performs the filtering based on reader identifiers, tag identifiers, timestamp, and event type.
